(19) United States
(12) Patent Application Publication
(10) Pub. No.: US 2023/0236405 A1
(43) Pub. Date: Jul. 27, 2023

(54) METHOD FOR OPERATING A STEREOSCOPIC MEDICAL MICROSCOPE, AND MEDICAL MICROSCOPE

(71) Applicant: Carl Zeiss Meditec AG, Jena (DE)

(72) Inventors: Felicia WALZ, Schwäbisch Gmünd (DE); Dominik SCHERER, Aalen (DE); Stefan SAUR, Aalen (DE); Marco WOERNER, Gerstetten (DE); Lars STOPPE, Jena (DE); Christian PLATT, Ulm (DE)

(21) Appl. No.: 18/100,886

(22) Filed: Jan. 24, 2023

(30) Foreign Application Priority Data
Jan. 25, 2022 (DE) 10 2022 200 819.7

(51) Int. Cl. G02B 21/22; G06T 7/00; G06T 7/80; G06V 10/24; G06V 10/44; G06V 10/74

(52) U.S. Cl. CPC G02B 21/22; G06T 7/0012; G06T 7/85; G06V 10/242; G06V 10/44; G06V 10/761; G06T 2207/10056

(57) ABSTRACT

The invention relates to a method for operating a stereoscopic medical microscope, wherein deteriorated and/or invalid calibration data are recognized, wherein for this purpose mutually corresponding image representations of at least one feature arranged in capture regions of cameras of a stereo camera system of the medical microscope are captured by means of the cameras, the captured image representations are evaluated by means of feature-based image processing, wherein the at least one feature is recognized in this case in the captured image representations and a misalignment and/or a decalibration of the cameras of the stereo camera system are/is recognized on the basis of the at least one feature recognized; and wherein at least one measure is carried out depending on an evaluation result. Furthermore, the invention relates to a medical microscope.

The invention relates to a method for operating a stereoscopic medical microscope, and to a medical microscope.

One aim of digital visualization in surgery and microsurgery is to provide for a surgeon, during an operation, an optimum three-dimensional image representation of an operation site and, if appropriate, an optimum three-dimensional superimposition of generated information onto a field of view on display devices (e.g. monitors or displays) of the medical microscope. An optimum superimposition of the image representations of cameras of a stereo camera system that is required for this is achieved by way of a digital calibration of the cameras.

The application of optimized calibration data sets makes it possible to avoid the occurrence of erroneous three-dimensional information superimpositions or an unpleasant presentation of the image representations, associated with e.g. frustration and fatigue phenomena for the surgeon. It is important here, in particular, for the calibration data always to be up-to-date in order to avoid a deterioration of the three-dimensional visualization.

Methods for the internal and external calibration of cameras of a stereo camera system, in particular for optimizing a three-dimensional superimposition of external information, are known, for example from DE 10 2019 131 646 A1 and EP 3 682 424 B1.

What is not taken into account by the methods, however, is that the calibration data can deteriorate or even become invalid over time as a result of various influences, which leads to a deterioration of the three-dimensional visualization. Reasons for this may be, in particular, external factors, such as impacts (a medical microscope is often moved back and forth between different operating rooms) and temperature changes, but also internal factors, such as increasing tolerances in a mechanism of optical components. These factors lead to displacements in the optical imaging paths of the medical microscope, such that the calibration data used for three-dimensional image optimization progressively become worse or even invalid.

The invention is based on the object of providing a method for operating a stereoscopic medical microscope, and a medical microscope, which enable deteriorated and/or invalid calibration data to be recognized, in particular during regular operation in the field.

According to the invention, the object is achieved by a method having the features of patent claim 1 and a medical microscope having the features of patent claim 13. Advantageous configurations of the invention are evident from the dependent claims.

One of the basic concepts of the invention is recognizing deteriorated and/or invalid calibration data on the basis of at least one feature which has been arranged or is arranged in capture regions of cameras of a stereo camera system. In this case, a capture region of a camera is intended to encompass in particular everything that can be captured in the field of view of the respective camera. Mutually corresponding image representations of the at least one feature are captured by means of the cameras and evaluated by means of feature-based image processing. The image processing involves recognizing the at least one feature in the captured image representations, wherein in particular methods of computer vision, of pattern recognition and/or of artificial intelligence (in particular machine learning methods) that are known per se can be used for this purpose. A misalignment and/or a decalibration of the cameras of the stereo camera system are/is recognized on the basis of the at least one feature recognized. For this purpose, in particular, a position of the at least one feature in the mutually corresponding image representations captured is determined and evaluated. At least one measure is carried out depending on, that is to say on the basis of, an evaluation result. In one simple case, a measure can comprise for example outputting the evaluation result in order to notify a user of the current state of the medical microscope. If no misalignment and/or decalibration are/is recognized, then in particular no measure is instigated or the measure includes no action.

In particular, a method for operating a stereoscopic medical microscope is provided, wherein deteriorated and/or invalid calibration data are recognized, wherein for this purpose
mutually corresponding image representations of at least one feature arranged in capture regions of cameras of a stereo camera system of the medical microscope are captured by means of the cameras,
the captured image representations are evaluated by means of feature-based image processing, wherein the at least one feature is recognized in this case in the captured image representations and a misalignment and/or a decalibration of the cameras of the stereo camera system are/is recognized on the basis of the at least one feature recognized, and

wherein at least one measure is carried out depending on an evaluation result.

Furthermore, in particular a medical microscope, in particular a stereoscopic medical microscope, is provided, comprising a stereo camera system having cameras configured for capturing in each case mutually corresponding image representations of capture regions of the cameras, and an image processing device configured for processing the captured image representations, wherein the image processing device is furthermore configured to recognize deteriorated and/or invalid calibration data and for this purpose to instigate capturing of mutually corresponding image representations of at least one feature arranged in the capture regions of the cameras of the stereo camera system, to evaluate the captured mutually corresponding image representations by means of feature-based image processing, wherein the at least one feature is recognized in this case in the captured image representations and a misalignment and/or a decalibration of the cameras of the stereo camera system are/is recognized on the basis of the at least one feature recognized, and to instigate at least one measure depending on an evaluation result.

The method and the medical microscope make it possible to check a quality of captured image representations and/or calibration data of the cameras of the medical microscope during regular operation of the medical microscope, that is to say in the field, that is to say at a regular operating location, and to take necessary measures depending on such checking, for example measures that comprise a recalibration of the cameras and/or a correction of the calibration data. The method can be used flexibly, regularly and in an automated manner in the field, such that in particular a quality of a three-dimensional visualization can be continuously monitored and kept constant. Regular operation is, in particular, operation of the medical microscope at a regular operating location in a surgical operating room or in an examination room. Regular operation is, in particular, operation during an examination or during a surgical operation on a patient.

A medical microscope is a surgical microscope in particular. However, a medical microscope may also be a microscope used for medical examinations and/or for diagnostic purposes, for example in the field of ophthalmology or in other fields.

Deteriorated calibration data comprise, in particular, calibration data with which work is still possible, but a three-dimensional visualization and/or superimposition is already qualitatively restricted. Invalid calibration data comprise, in particular, calibration data with which a satisfactory three-dimensional visualization and/or superimposition can no longer be achieved at all. In this case, at least one quality criterion (e.g. in the form of limit values for an offset and/or a rotation, etc.) can also be used to recognize deteriorated and/or invalid calibration data.

The at least one feature can be for example a feature of an (artificial) object arranged in the capture region. The at least one feature can also be a feature in an operation site. Furthermore, the at least one feature can also be a virtual feature which for example is inserted and/or projected into a capture region or is injected into a beam path.

The evaluating by means of the feature-based image processing can be effected for example by means of a method of artificial intelligence and/or by means of traditional image processing. Three examples are described briefly below.

In the first example, the at least one feature comprises a checkered pattern that is captured in the image representations. A trained method of artificial intelligence, for example a trained neural network, receives as input data the captured left image representation and the captured right image representation of the checkered pattern. As output data, the trained method of artificial intelligence yields for example a probability and a value for an offset, for example in the x-direction and/or the y-direction, and/or a rotation (in particular a rotation angle or rotation difference angle). During a training phase, the method of artificial intelligence was trained with the aid of training data which were obtained by targeted decalibration of the cameras of the stereo camera system and for which an extent of the decalibration, for example an offset, on account of the decalibration performed in a targeted manner, is known as respective ground truth.

In the second example, the at least one feature likewise comprises a checkered pattern that is captured by the cameras. Both in the captured left image representation and in the captured right image representation, by means of traditional image processing intersection points of fields of the checkered pattern are determined, for example by means of an edge filter. This is followed by determining mutually corresponding intersection points in the left and right image representations. For the respectively mutually corresponding intersection points, for example an Euclidean distance (with reference to the coordinate systems of image elements in the captured image representations) is determined in each case. On the basis of the Euclidean distances determined, for example an error measure for an offset and/or a rotation is determined and provided as evaluation result. In this case, the random sample consensus (RANSAC) method can also be used in order for example to identify outliers.

In the third example, an operation scene is captured in the image representations. In the captured image representations, keypoints are determined and described with the aid of features (e.g. with the aid of Speeded Up Robust Features [SURF], Scale-Invariant Feature Transform [SIFT], Features from accelerated segment test [FAST], Binary Robust Independent Elementary Features [BRIEF] and/or Oriented FAST and rotated BRIEF [ORB] etc.). Corresponding keypoints are determined in the left and right image representations. This is followed by determining in particular distances between the respective feature vectors of mutually corresponding keypoints in the left and right image representations. On the basis of the distances determined, for example an error measure for an offset and/or a rotation and/or a scaling is determined and provided as evaluation result. Here, too, the RANSAC method can be used in order to identify outliers.

Parts of the medical microscope, in particular the image processing device and/or a control device of the medical microscope, can be designed, either individually or together, as a combination of hardware and software, for example as program code that is executed on a microcontroller or microprocessor. However, provision can also be made for parts to be designed as application-specific integrated circuits (ASICs) and/or field-programmable gate arrays (FPGAs), either on their own or in combination.

In one embodiment, it is provided that during the evaluating on the basis of the at least one feature recognized an offset at least in one direction between the mutually corresponding image representations captured is determined and provided as evaluation result. This enables an offset to be concomitantly included in the evaluation. By way of the offset, a decalibration can be ascertained particularly simply. By way of example, an offset in the y-direction, that is to say an offset of the at least one feature in the line of the image elements in the captured (left and right) image representations, can be determined and a measure can be carried out depending on the determined offset in the y-direction. By way of example, the determined offset in the y-direction can be corrected by adapting the calibration data of the cameras, such that the at least one feature in both image representations appears in the same line again. Furthermore, alternatively or additionally, an offset in the x-direction can also be determined and corrected in the context of a measure. The procedure is basically analogous here, wherein the special characteristics of the stereoscopic imaging path are always taken into account (in particular a desired parallax).

In one embodiment, it is provided that during the evaluating on the basis of the at least one feature recognized a rotation (in particular a rotation angle or rotation difference angle) between the mutually corresponding image representations captured is determined and provided as evaluation result. This enables a rotation to be concomitantly included in the evaluation. By way of example, depending on the determined rotation, subsequently as measure, calibration data of the cameras of the stereo camera system can be adapted in such a way as to compensate for the rotation between the image representations.

In one embodiment, it is provided that for the purpose of checking a focus position calibration, a sharpness of the at least one feature in the image representations respectively captured by the cameras is determined, wherein a difference between the sharpnesses determined is determined and provided as evaluation result. This enables a focus position to be concomitantly included in the evaluation. In a subsequent measure, the focus positions of the cameras can be adapted by adapting the calibration data and/or a recalibration and/or readjustment can be instigated.

In one embodiment, it is provided that during the capturing of the image representations, the at least one feature is injected into a respective capture region and/or a respective beam path of the cameras of the stereo camera system by means of at least one injection device of the medical microscope. This enables the feature to be provided in virtual form. Furthermore, a suitable feature can be generated in any desired form since the feature is generated digitally. The method becomes more flexible as a result. In particular, the calibration data or a quality of the captured image representations can be checked without further measures during regular operation since the at least one feature can be injected at any time and, moreover, also only for a short duration. The at least one injection device can be a data injection device integrated into the respective beam path (e.g. an integrated data injection system, IDIS), for example, which is known per se. The cameras then in each case also capture injected information, in particular the at least one feature injected. By way of example, for this purpose, the at least one feature can have a checkered pattern, lines and/or colored patterns with defined horizontal and vertical edges and structures. Furthermore, it is thereby possible for the feature to be injected only for such a short duration that a human observer cannot consciously perceive it (e.g. for a duration of <50 ms). The injection can also be effected during an idle state and/or during starting up and/or shutting down of the medical microscope.

In one embodiment, it is provided that the at least one feature, for the purpose of capturing, is arranged in the capture regions and/or in an intermediate image plane of the medical microscope in an automated manner by means of a feature actuator system and/or that the stereo camera system, for the purpose of capturing, is moved in an automated manner by means of an actuator system, such that the at least one feature is arranged in the capture regions. This enables a physically embodied feature to be provided. In particular, this enables a complete optical imaging section to be checked. In this case, provision can also be made for the actuator system to move the stereo camera system in such a way that a feature displayed on a display device (e.g. a monitor) of the medical microscope and/or a feature (e.g. calibration object or manufacturer's logo) arranged on a stand and/or a console of the medical microscope can be captured. If the at least one feature is arranged in an intermediate image plane of the medical microscope, then it is not arranged outside the medical microscope, but rather within the imaging path.

In one embodiment, it is provided that capturing the image representations, recognizing the deteriorated and/or invalid calibration data and carrying out the at least one measure are/is carried out in an automated manner during starting up and/or shutting down and/or during an idle state of the medical microscope. As a result, checking in respect of a deterioration and/or a validity of the calibration data and/or a quality of the captured image representations can be carried out regularly, such that a quality of captured image representations and of a three-dimensional visualization can be continually checked. By way of example, provision can be made, each time the medical microscope is started up and/or shut down and/or during an idle state of the medical microscope, for injecting the at least one feature by means of the at least one injection device, capturing image representations in respect thereof, and evaluating the latter as described.

In one embodiment, it is provided that capturing the image representations, recognizing the deteriorated and/or invalid calibration data and carrying out the at least one measure are/is carried out during regular operation of the medical microscope. As a result, even during regular operation of the medical microscope, an alignment and/or a calibration of the cameras of the stereo camera system can be checked and a misalignment and/or decalibration can be recognized. The captured image representations can also be, in particular, captured live image representations during an operation.

In one embodiment, it is provided that the evaluation result is compared with at least one predefined limit value, wherein the at least one measure is selected depending on a comparison result. This enables limit value-dependent measures to be instigated. In particular, a plurality of limit values can be provided, such that a gradation of different measures can be implemented. The at least one predefined limit value can be determined for example by definition and/or with the aid of empirical experiments and/or simulations. Furthermore, a method of artificial intelligence can also be used to determine, in particular estimate, the at least one limit value proceeding from surgeons' feedback as to when a deteriorated quality in the three-dimensional visualization is found to be disturbing. The at least one predefined limit value can concern for example an offset and/or a rotation between the captured image representations and/or a difference in the focus positions of the cameras.

In one embodiment, it is provided that a first limit value has been predefined or is predefined, wherein as measure calibration data are determined and/or adapted if the evaluation result is greater than or equal to the predefined first limit value.

In one embodiment, it is provided that the evaluation result is stored in a maintenance database operated for anticipatory maintenance if the evaluation result lies below the predefined first limit value. This enables a maintenance date to be estimated anticipatorily in particular by way of a trend analysis of comparison results stored over the course of time. In particular, this enables reaction already at an early stage if the trend analysis reveals that the calibration data are increasingly deteriorating. The maintenance database can for example be stored in a memory of a control device of the medical microscope and/or be provided by a central server and/or by way of a cloud-based solution.

In one embodiment, it is provided that a second limit value has been predefined or is predefined, wherein as measure a service message is generated and displayed and/or sent if the evaluation result is greater than or equal to the predefined second limit value. This enables a service measure to be instigated for example in the case of a particularly large offset and/or a particularly large rotation between the captured image representations and/or a particularly large difference in the focus positions of the cameras of the stereo camera system. The service message is communicated to a central server, for example a central server of a manufacturer of the medical microscope, for example via a communication connection.

Further features relating to the configuration of the medical microscope are evident from the description of configurations of the method. Here, the advantages of the medical microscope are in each case the same as in the configurations of the method.

The invention is explained in greater detail below on the basis of preferred exemplary embodiments with reference to the figures. In the figures:

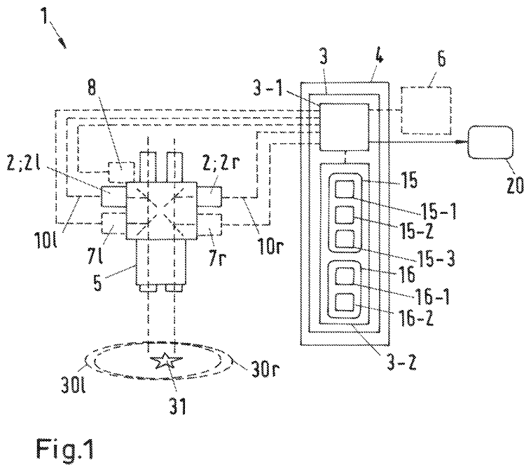

FIG. 1 shows a schematic illustration of one embodiment of the medical microscope;

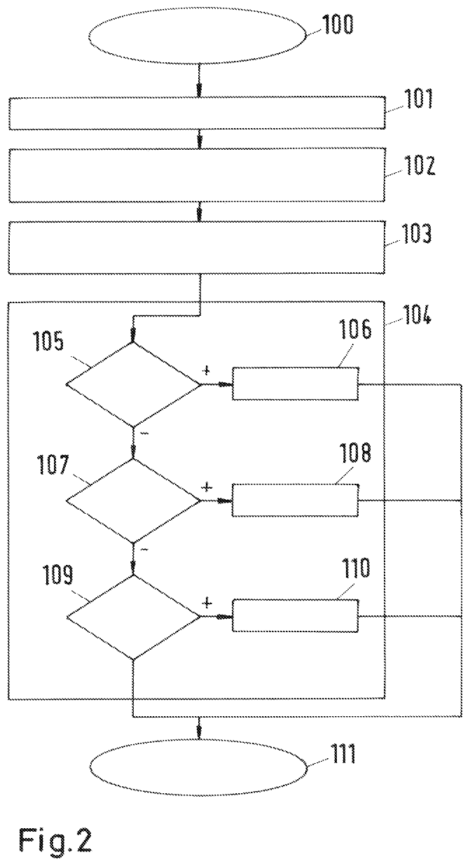

FIG. 2 shows a schematic flow diagram of one embodiment of the method for operating a stereoscopic medical microscope.

FIG. 1 shows a schematic illustration of one embodiment of the medical microscope 1. The medical microscope 1 comprises a stereo camera system 2 having a left camera 21 and a right camera 2r. Furthermore, the medical microscope 1 comprises an image processing device 3. The image processing device 3 comprises a computing device 3-1 and a memory 3-2. The image processing device 3 can be part of a control device 4 of the medical microscope 1 and/or be provided by said control device. The medical microscope 1 is a surgical microscope, for example. The method described in this disclosure is explained in more detail below on the basis of the medical microscope 1.

In principle, the control device 4 and/or the image processing device 3 can also be embodied as microscope-external devices which are provided for example by means of an external data processing device, for example by means of a desktop, laptop or tablet computer, or else by means of a cloud-based solution.

The left camera 21 captures a left image representation 101 of a left capture region 301 via a stereoscopic imaging optical unit 5 and the right camera 2r captures a right image representation 10r— corresponding thereto—of a right capture region 30r. In particular, provision is made for the cameras 21, 2r to generate raw signals by means of image sensors, the image representations 101, 10r being generated from said raw signals by way of signal technology, calibration data being taken into account here, which correct for example an offset and/or a rotation between the captured image representations 101, 10r by way of signal technology. The captured image representations 101, 10r can subsequently be displayed on a display device 6 of the medical microscope 1.

The image processing device 3 is configured for processing the captured image representations 101, 10r. The image processing device 3 is furthermore configured to recognize deteriorated and/or invalid calibration data and for this purpose to instigate capturing of mutually corresponding image representations 101, 10r of at least one feature 31 arranged in the capture regions of the cameras 21, 2r of the stereo camera system 2. The image processing device 3 evaluates the mutually corresponding image representations 101, 10r captured, wherein the at least one feature 31 is recognized in this case in the captured image representations 101, 10r and a misalignment and/or a decalibration of the cameras 21, 2r of the stereo camera system 2 are/is recognized on the basis of the at least one feature 31 recognized. The image processing device 3 instigates at least one measure 20 depending on an evaluation result 15 obtained.

It can be provided that during the evaluating on the basis of the at least one feature 31 recognized an offset 15-1 at least in one direction between the mutually corresponding image representations 101, 10r captured is determined and provided as evaluation result 15 by means of the image processing device 3. The offset 15-1 comprises for example a difference between positions of image elements which correspond to the at least one feature 31 in the captured image representations 101, 10r. By way of example, at least one line difference (offset in the y-direction) can be determined. However, additionally or alternatively, a column difference (offset in the x-direction) can also be determined.

Furthermore, other error measures can also be determined, for example a Euclidean distance between said image elements in the two captured image representations 101, 10r.

It can be provided that during the evaluating on the basis of the at least one feature 31 recognized a rotation 15-2, in particular a rotation angle or rotation difference angle, between the mutually corresponding image representations 101, 10r captured is determined and provided as evaluation result 15. In this case, the rotation 15-2 denotes in particular a rotation 15-2 around an image center point of the image representations 101, 10r. Methods from the field of computer vision and/or methods of artificial intelligence known per se can be used for determining the rotation 15-2.

It can be provided that for the purpose of checking a focus position calibration, a sharpness of the at least one feature 31 in the image representations 101, 10r respectively captured by the cameras 21, 2r is determined, wherein a difference 15-3 between the sharpnesses determined is determined and provided as evaluation result 15.

It can be provided that during the capturing of the image representations 101, 10r, the at least one feature 31 is injected into a respective capture region 301, 30r and/or a respective beam path of the cameras 21, 2r of the stereo camera system 2 by means of a left injection device 71 and a right injection device 7r of the medical microscope 1. In principle, it is also possible to use just one (common) injection device situated in a common optical path of the cameras 21, 2r. The at least one feature 31 is injected into a respective beam path of the imaging optical unit 5 in particular at the position of the injection devices 71, 7r (by means of a semitransparent mirror), such that said at least one feature can be captured in each case by image sensors of the cameras 21, 2r. The injection devices 71, 7r are controlled for example by means of the control device 4 of the medical microscope 1. The information to be injected, in particular the at least one feature 31 to be injected, is likewise generated and provided by the control device 4. An injection device can be for example an Integrated Data Injection System (IDIS) from Carl Zeiss Meditec AG.

It can be provided that the at least one feature 31, for the purpose of capturing, is arranged in the capture regions 301, 301 in an automated manner by means of a feature actuator system (not shown) and/or that the stereo camera system 2, for the purpose of capturing, is moved in an automated manner by means of an actuator system 8, such that the at least one feature 31 is arranged in the capture regions 301, 30r. For this purpose, the actuator system 8 is controlled by means of the control device 4. The feature actuator system for arranging the at least one feature 31 in the capture regions 301, 30r can comprise a pivot arm, for example, by means of which a calibration object with the at least one feature 31 can be pivoted into the capture regions 301, 30r.

It can be provided that capturing the image representations 101, 10r, recognizing the deteriorated and/or invalid calibration data and carrying out the at least one measure 20 are/is carried out in an automated manner during starting up and/or shutting down and/or during an idle state of the medical microscope 1. This can be initiated by the control device 4 and/or by the image processing device 3. By way of example, checking the calibration can be a process that is permanently integrated in a sequence of starting up and/or shutting down the medical microscope 1. An idle state can be recognized for example by means of the image processing device 3, wherein the latter for this purpose continually evaluates captured image representations 101, 10r and instigates the checking if (in particular whenever) the content imaged in the image representations 101, 10r does not change for a predefined minimum duration. Furthermore, an idle state can also be recognized by monitoring parameters or changes in parameters of the medical microscope 1. If no parameters, in particular no control parameters of an actuator system of the medical microscope 1, are changed for a predefined time, then an idle state is recognized. Furthermore, a software interrogation can also take place, which establishes whether or not the medical microscope 1 is in an idle state. An idle state can also be recognized, in particular, if no interaction with the medical microscope 1 takes place for a predefined duration.

It can also be provided that capturing the image representations 101, 10r, recognizing the deteriorated and/or invalid calibration data and carrying out the at least one measure 20 are/is carried out during regular operation of the medical microscope 1.

It can be provided that the evaluation result 15 is compared with at least one predefined limit value 16, wherein the at least one measure 20 is selected depending on a comparison result. A limit value 16 can have been predefined or be predefined for example for an offset 15-1, a rotation 15-2, a difference 15-3 between the determined sharpnesses (focus position) and/or for some other error measure. The comparing takes place in the image processing device 3 and/or in the control device 4.

It can be provided that a first limit value 16-1 has been predefined or is predefined, wherein as measure 20 calibration data are determined and/or adapted if the evaluation result 15 is greater than or equal to the predefined first limit value 16-1.

It can furthermore be provided that the evaluation result 15 is stored in a maintenance database operated for anticipatory maintenance if the evaluation result 15 lies below the predefined first limit value 16-1.

It can be provided that a second limit value 16-2 has been predefined or is predefined, wherein as measure 20 a service message is generated and displayed and/or sent if the evaluation result 15 is greater than or equal to the predefined second limit value 16-2.

FIG. 2 shows a schematic flow diagram of one embodiment of the method for operating a stereoscopic medical microscope. The medical microscope is configured for example like the embodiment shown in FIG. 1.

The method is started in a method step 100 when the medical microscope starts up for (regular) operation and/or when the medical microscope shuts down after (regular) operation.

In a method step 101, at least one feature is injected into beam paths of cameras of a stereo camera system by means of injection devices (e.g. IDIS). The at least one feature comprises a checkered pattern, for example. The checkered pattern is then injected into the left and right beam paths (or alternatively into a common beam path/path), such that the respective checkered patterns can be captured by the left and right cameras.

In a method step 102, mutually corresponding image representations of the at least one feature arranged in the capture regions of the cameras of the stereo camera system of the medical microscope are captured by means of the cameras. In particular, the checkered patterns respectively injected into the beam paths are captured. The captured image representations are evaluated by means of feature-based image processing. In particular, in this case, positions of the individual checkered squares in the checkered patterns are determined, for example with the aid of edge filters.

In method step 103, an x-/y-offset and/or a rotation, in particular a rotation angle, between the captured image representations and/or, in a manner corresponding thereto, between the cameras of the stereo camera system are/is determined and provided as evaluation result. It can also be provided that an aggregate error measure is determined and provided as evaluation result, which can comprise an x-offset and/or a y-offset and/or a rotation and/or further variables.

In method step 104, the evaluation result is compared with predefined limit values in order thereby to determine measures which are intended to be carried out and/or instigated. Method step 104 comprises method steps 105-110. In this case, it can be provided that the variables determined in method step 103 are compared with respective predefined limit values or that a (single) aggregate error measure is compared with respective predefined limit values.

Method step 105 involves checking whether the evaluation result (individual value or aggregate error measure) is less than a first predefined limit value. If this is the case, then in method step 106 the evaluation result is stored in a maintenance database operated for anticipatory maintenance.

Method step 107 involves checking whether the evaluation result (individual value or aggregate error measure) is greater than or equal to the first predefined limit value. If this is the case, then in a method step 108 calibration data are determined and/or adapted in a manner known per se. It can furthermore be provided that after determining and/or adapting the calibration data, the at least one feature, in particular the injected checkered patterns, are once again captured and evaluated in order to check an effectiveness of the determined and/or adapted calibration data.

Method step 109 involves checking whether the evaluation result (individual value or aggregate error measure) is less than a second predefined limit value. In this case, the second predefined limit value is chosen to be, in particular, greater than the first predefined limit value. If this is the case, then in method step 110 a service message is generated and displayed and/or sent, for example to a central server of a manufacturer of the medical microscope and/or of a maintenance service provider. In this way, in the case of a very severe misalignment and/or decalibration, a service action can be instigated in an automated manner.

The method is subsequently ended 111.

One of the advantages of the method described in this disclosure and of the medical microscope is the possibility of constantly monitoring a quality of captured image representations of the cameras of the stereo camera system in an automated manner, and being able to take suitable measures in the event of a decrease in this quality. Overall, a three-dimensional visualization with consistently high quality can be provided as a result.

### LIST OF REFERENCE SIGNS

1 Medical microscope
2 Stereo camera system
21 Left camera
2r Right camera
3 Image processing device
3-1 Computing device
3-2 Memory
4 Control device
5 Stereoscopic imaging optical unit
6 Display device
71 Left injection device
7r Right injection device
8 Actuator system
101 Left image representation
10r Right image representation
15 Evaluation result
15-1 Offset
15-2 Rotation
15-3 Difference (focus positions)
16 Limit value
16-1 First limit value
16-2 Second limit value
20 Measure
301 Capture region (left camera)
30r Capture region (right camera)
31 Feature
100-111 Method steps of the method

1. A method for operating a stereoscopic medical microscope, wherein deteriorated and/or invalid calibration data are recognized,
wherein for this purpose
mutually corresponding image representations of at least one feature arranged in capture regions of cameras of a stereo camera system of the medical microscope are captured by means of the cameras,
the captured image representations are evaluated by means of feature-based image processing, wherein the at least one feature is recognized in this case in the captured image representations and a misalignment and/or a decalibration of the cameras of the stereo camera system are/is recognized on the basis of the at least one feature recognized, and
wherein at least one measure is carried out depending on an evaluation result.

2. The method as claimed in claim 1, wherein during the evaluating on the basis of the at least one feature recognized an offset at least in one direction between the mutually corresponding image representations captured is determined and provided as evaluation result.

3. The method as claimed in claim 1, wherein during the evaluating on the basis of the at least one feature recognized a rotation between the mutually corresponding image representations captured is determined and provided as evaluation result.

4. The method as claimed in claim 1, wherein for the purpose of checking a focus position calibration, a sharpness of the at least one feature in the image representations respectively captured by the cameras is determined, wherein a difference between the sharpnesses determined is determined and provided as evaluation result.

5. The method as claimed in claim 1, wherein during the capturing of the image representations, the at least one feature is injected into a respective capture region and/or a respective beam path of the cameras of the stereo camera system by means of at least one injection device of the medical microscope.

6. The method as claimed in claim 1, wherein the at least one feature, for the purpose of capturing, is arranged in the capture regions and/or in an intermediate image plane of the medical microscope in an automated manner by means of a feature actuator system and/or wherein the stereo camera system, for the purpose of capturing, is moved in an automated manner by means of an actuator system, such that the at least one feature is arranged in the capture regions.

7. The method as claimed in claim 1, wherein capturing the image representations, recognizing the deteriorated and/or invalid calibration data and carrying out the at least one measure are/is carried out in an automated manner during starting up and/or shutting down and/or during an idle state of the medical microscope.

8. The method as claimed in claim 1, wherein capturing the image representations, recognizing the deteriorated and/or invalid calibration data and carrying out the at least one measure are/is carried out during regular operation of the medical microscope.

9. The method as claimed in claim 1, wherein the evaluation result is compared with at least one predefined limit value, wherein the at least one measure Q is selected depending on a comparison result.

10. The method as claimed in claim 9, wherein a first limit value has been predefined or is predefined, wherein as measure calibration data are determined and/or adapted if the evaluation result is greater than or equal to the predefined first limit value.

11. The method as claimed in claim 10, wherein the evaluation result is stored in a maintenance database operated for anticipatory maintenance if the evaluation result lies below the predefined first limit value.

12. The method as claimed in claim 9, wherein a second limit value has been predefined or is predefined, wherein as measure a service message is generated and displayed and/or sent if the evaluation result is greater than or equal to the predefined second limit value.

13. A medical microscope, comprising:
a stereo camera system having cameras, configured for capturing in each case mutually corresponding image representations of capture regions of the cameras, and
an image processing device, configured for processing the captured image representations,
wherein the image processing device is furthermore configured to recognize deteriorated and/or invalid calibration data and for this purpose to instigate capturing of mutually corresponding image representations of at least one feature arranged in the capture regions of the cameras of the stereo camera system,
to evaluate the captured mutually corresponding image representations by means of feature-based image processing, wherein the at least one feature is recognized in this case in the captured image representations and a misalignment and/or a decalibration of the cameras of the stereo camera system are/is recognized on the basis of the at least one feature recognized, and to instigate at least one measure depending on an evaluation result.
